(19) United States
(12) Patent Application Publication
(10) Pub. No.: US 2025/0377202 A1
(43) Pub. Date: Dec. 11, 2025

(54) SELF-POSITION ESTIMATION DEVICE, SELF-POSITION ESTIMATION METHOD, AND PROGRAM

(71) Applicant: MITSUBISHI HEAVY INDUSTRIES, LTD., Tokyo (JP)

(72) Inventors: Kenta NAKAO, Tokyo (JP); Kiichi SUGIMOTO, Tokyo (JP); Mizuho TAKEUCHI, Tokyo (JP); Yusuke KINOUCHI, Tokyo (JP); Kenji TAKAO, Tokyo (JP); Yusuke HAZUI, Tokyo (JP)

(73) Assignee: MITSUBISHI HEAVY INDUSTRIES, LTD., Tokyo (JP)

(21) Appl. No.: 18/876,510

(22) PCT Filed: Feb. 17, 2023
(86) PCT No.: PCT/JP2023/005802

§ 371 Date: Dec. 18, 2024

(30) Foreign Application Priority Data
Jun. 29, 2022 (JP) 2022-104777

(51) Int. Cl. G01C 21/20; B66F 9/06; G05D 1/244; G05D 107/70; G05D 111/50

(52) U.S. Cl. CPC G01C 21/206; B66F 9/063; G05D 1/244; G05D 2107/70; G05D 2111/52

(57) ABSTRACT

This self-position estimation device is equipped with: a first acquisition unit which acquires first sensor data which makes it possible to detect a fixed object which is always present in the periphery of an autonomous moving body and an unfixed object which is temporarily present therein; a second acquisition unit for acquiring second sensor data which includes the acceleration and the angular velocity of the autonomous moving body; a first estimation unit for estimating a partial parameter, which is one part of a parameter of the six degrees-of-freedom, which represent the position and the orientation of the autonomous moving body in a three-dimensional coordinate system, on the basis of the first sensor data and known information, which records information including the position in the area of travel of a mark, which is one fixed object selected in advance from among the plurality of fixed objects; and a second estimation unit for estimating the self-position of the autonomous moving body on the basis of the first sensor data, the second sensor data and the partial parameter.

### TECHNICAL FIELD

The present disclosure relates to a self-position estimation device, a self-position estimation method, and a program of an autonomous moving body.

Priority is claimed to Japanese Patent Application No. 2022-104777, filed Jun. 29, 2022, the content of which is incorporated herein by reference.

### BACKGROUND ART

An autonomous moving body used in logistics, plant inspection, or the like collates map data created in advance based on sensor data acquired by, for example, a laser sensor or a camera (image sensor) with current sensor data to estimate a self-position (position and posture with respect to each axis of a three-dimensional coordinate system) of the autonomous moving body. However, for example, in a case where the autonomous moving body is operated in a facility in which a passage is formed by stacking a plurality of packages, such as a logistics warehouse, these packages are non-fixed objects that are temporarily present, and thus cannot be reflected in the map data in advance. In this case, there is a possibility that the estimation accuracy of the self-position of the autonomous moving body is decreased in the area where the package is temporarily placed.

Therefore, in an area where it is difficult to estimate the self-position by means of the laser sensor or the camera, a technology for estimating the self-position by substituting other sensors is considered. For example, PTL 1 discloses a method of acquiring sensor data measured by each of a plurality of different sensors such as an encoder, an inertial measurement unit (IMU), a global navigation satellite system (GNSS) receiver, a camera, and a laser sensor, estimating each of self-position candidates of the autonomous moving body from each of the sensor data, and deciding a self-position candidate having a highest reliability degree as a self-position of the autonomous moving body.

### CITATION LIST

### Patent Literature

[PTL 1] Japanese Unexamined Patent Application Publication No. 2020-87307

### SUMMARY OF INVENTION

### Technical Problem

However, in the technology of PTL 1, one candidate is selected from self-position candidates independently estimated from each sensor data and determined as a self-position, and thus accuracy of a self-position depends on a self-position estimation result of a sensor.

In addition, a self-position estimation technology in which a plurality of sensors are combined is considered. In visual inertial odometry (VIO) of the self-position estimation technology in which a camera and an IMU are combined, a self-position at which a movement amount of a feature point obtained from a camera image matches an acceleration and an angular velocity obtained from the IMU is calculated by optimization calculation (for example, a nonlinear least squares method).

However, since such an odometry method solves a local optimization problem viewed on a time axis, drift in which an estimated position gradually deviates from an actual position may occur due to accumulation of errors. There is a demand for a technology capable of reducing an influence of such a cumulative error and the like and accurately estimating the self-position.

An object of the present disclosure is to provide a self-position estimation device, a self-position estimation method, and a program capable of accurately estimating a position and a posture of an autonomous moving body.

### Solution to Problem

With one aspect of the present disclosure, a self-position estimation device that estimates a self-position in a driving area of an autonomous moving body, includes a first acquisition unit that acquires first sensor data capable of detecting a fixed object always present in a periphery of the autonomous moving body and a non-fixed object temporarily present in the periphery of the autonomous moving body; a second acquisition unit that acquires second sensor data including an acceleration and an angular velocity of the autonomous moving body; a first estimation unit that estimates a partial parameter that is a part of six degrees-of-freedom parameters representing a position and a posture of the autonomous moving body in a three-dimensional coordinate system, based on known information, in which information including a position in the driving area of a mark that is one fixed object selected in advance from a plurality of fixed objects is recorded, and on the first sensor data; and a second estimation unit that estimates a self-position of the autonomous moving body represented by the six degrees-of-freedom parameters based on the first sensor data, the second sensor data, and the partial parameter.

With one aspect of the present disclosure, a self-position estimation method that estimates a self-position in a driving area of an autonomous moving body, includes a step of acquiring first sensor data capable of detecting a fixed object always present in a periphery of the autonomous moving body and a non-fixed object temporarily present in the periphery of the autonomous moving body; a step of acquiring second sensor data including an acceleration and an angular velocity of the autonomous moving body; a step of estimating a partial parameter that is a part of six degrees-of-freedom parameters representing a position and a posture of the autonomous moving body in a three-dimensional coordinate system, based on known information, in which information including a position in the driving area of a mark that is one fixed object selected in advance from a plurality of fixed objects is recorded, and on the first sensor data; and a step of estimating a self-position of the autonomous moving body represented by the six degrees-of-freedom parameters based on the first sensor data, the second sensor data, and the partial parameter.

With one aspect of the present disclosure, a program causes a self-position estimation device that estimates a self-position in a driving area of an autonomous moving body to execute: a step of acquiring first sensor data capable of detecting a fixed object always present in a periphery of the autonomous moving body and a non-fixed object temporarily present in the periphery of the autonomous moving body; a step of acquiring second sensor data including an acceleration and an angular velocity of the autonomous moving body; a step of estimating a partial parameter that is a part of six degrees-of-freedom parameters representing a position and a posture of the autonomous moving body in a three-dimensional coordinate system, based on known information, in which information including a position in the driving area of a mark that is one fixed object selected in advance from a plurality of fixed objects is recorded, and on the first sensor data; and a step of estimating a self-position of the autonomous moving body represented by the six degrees-of-freedom parameters based on the first sensor data, the second sensor data, and the partial parameter.

### Advantageous Effects of Invention

According to the above-described aspect, it is possible to estimate the position and the posture of the autonomous moving body with high accuracy.

### BRIEF DESCRIPTION OF DRAWINGS

FIG. 1 is a schematic diagram showing an overall configuration of an autonomous moving body according to a first embodiment.

FIG. 2 is a block diagram showing a functional configuration of a self-position estimation device according to the first embodiment.

FIG. 3 is a flowchart showing an example of processing of the self-position estimation device according to the first embodiment.

FIG. 4 is a flowchart showing an example of processing of a first estimation unit according to the first embodiment.

FIG. 5 is a diagram showing a function of the self-position estimation device according to the first embodiment.

FIG. 6 is a flowchart showing an example of processing of a second estimation unit according to the first embodiment.

FIG. 7 is a diagram showing a function of a self-position estimation device according to the second embodiment.

FIG. 8 is a flowchart showing an example of processing of a first estimation unit according to the second embodiment.

FIG. 9 is a first diagram showing a function of a self-position estimation device according to a third embodiment.

FIG. 10 is a second diagram showing the function of the self-position estimation device according to the third embodiment.

FIG. 11 is a flowchart showing an example of processing of a first estimation unit according to the third embodiment.

FIG. 12 is a third diagram showing the function of the self-position estimation device according to the third embodiment.

FIG. 13 is a fourth diagram showing the function of the self-position estimation device according to the third embodiment.

FIG. 14 is a diagram showing a function of a self-position estimation device according to a fourth embodiment.

FIG. 15 is a flowchart showing an example of processing of a first estimation unit according to the fourth embodiment.

FIG. 16 is a flowchart showing an example of processing of a second estimation unit according to a fifth embodiment.

FIG. 17 is a flowchart showing an example of processing of a second estimation unit according to a sixth embodiment.

### DESCRIPTION OF EMBODIMENTS

### First Embodiment

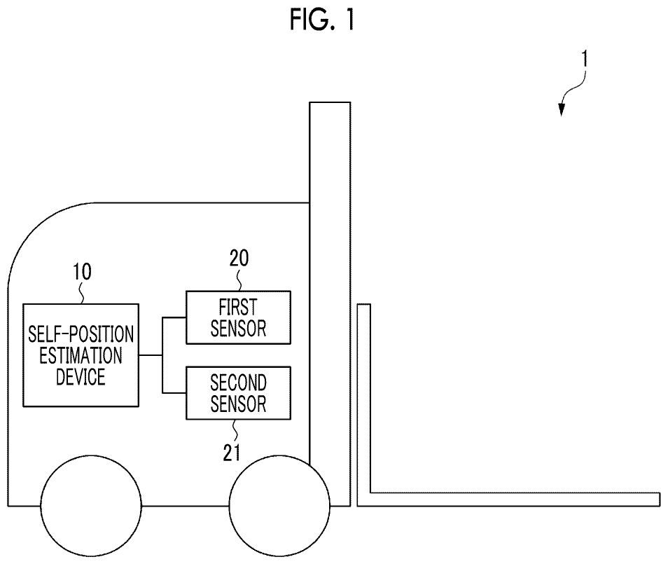

Hereinafter, a first embodiment will be described in detail with reference to FIGS. 1 to 6.

### Overall Configuration of Autonomous Moving Body

FIG. 1 is a schematic diagram showing an overall configuration of an autonomous moving body according to a first embodiment.

As shown in FIG. 1, an autonomous moving body 1 according to the present embodiment is, for example, an unmanned forklift that autonomously drives to a target point along a driving route determined in advance in a driving area such as a logistics warehouse. In other embodiments, the autonomous moving body 1 may be an inspection robot or the like used for plant inspection or the like.

The autonomous moving body 1 includes a self-position estimation device 10, a first sensor 20, and a second sensor 21.

The first sensor 20 is a camera that acquires image data (each frame of video data) obtained by imaging a periphery of the autonomous moving body 1.

The second sensor 21 is an inertial measurement device (hereinafter, also referred to as an “IMU”) that measures an acceleration and an angular velocity of the autonomous moving body 1.

The self-position estimation device 10 estimates a self-position of the autonomous moving body 1 based on the image data (first sensor data) acquired by the first sensor 20 and on the acceleration and the angular velocity (second sensor data) measured by the second sensor 21.

### Functional Configuration of Self-Position Estimation Device

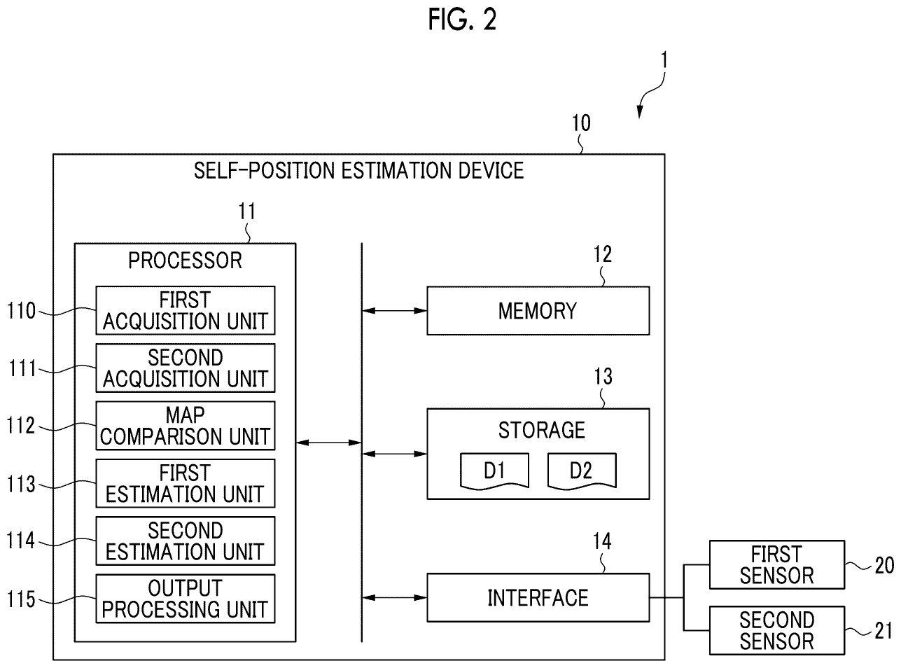

FIG. 2 is a block diagram showing a functional configuration of the self-position estimation device according to the first embodiment.

As shown in FIG. 2, the self-position estimation device 10 includes a processor 11, a memory 12, a storage 13, and an interface 14.

The memory 12 includes a memory area necessary for an operation of the processor 11.

The storage 13 is a so-called auxiliary storage device, and is, for example, a hard disk drive (HDD), a solid-state drive (SSD), or the like.

The interface 14 is an interface for transmitting and receiving various types of information to and from an external device (for example, the first sensor 20 and the second sensor 21).

The processor 11 operates in accordance with a predetermined program to exhibit functions as a first acquisition unit 110, a second acquisition unit 111, a map comparison unit 112, a first estimation unit 113, a second estimation unit 114, and an output processing unit 115.

The first acquisition unit 110 acquires image data (first sensor data) capable of detecting a fixed object always present in the periphery of the autonomous moving body 1 and a non-fixed object temporarily present in the periphery of the autonomous moving body 1, from the first sensor 20. For example, the fixed object is a structure in which a disposition or shape of a ceiling, a floor, a shelf, a signboard, paint, or the like in the driving area does not change. In addition, the non-fixed object is a package, a palette, or the like that is temporarily placed on a floor, a shelf, or the like.

The second acquisition unit 111 acquires the acceleration and the angular velocity (second sensor data) of the autonomous moving body 1 from the second sensor 21.

The map comparison unit 112 collates the first sensor data with map data D1 recorded in the storage 13 in advance to estimate the self-position of the autonomous moving body 1. The self-position of the autonomous moving body 1 is represented by six degrees-of-freedom parameters consisting of positions in each of directions of coordinate axes (Xw, Yw, and Zw) of a world coordinate system and rotation angles (postures) around each coordinate axis.

The map data D1 is a set of sample data in which the first sensor data is collected by causing the autonomous moving body 1 to perform test running in the driving area in advance, and the self-position of the autonomous moving body 1 at a point in time when each first sensor data is acquired is added to each first sensor data. The map comparison unit 112 collates the first sensor data acquired by the first acquisition unit 110 with each sample data of the map data D1, and estimates the self-position attached to the sample data that matches the first sensor data as the self-position of the autonomous moving body 1.

The first estimation unit 113 estimates a partial parameter, which is at least one of six degrees-of-freedom parameters representing a position and a posture in a three-dimensional coordinate system, based on known information D2 recorded in the storage 13 in advance and on the first sensor data. The known information D2 is information in which a position, an angle, a shape, and the like of a mark, which is one fixed object selected in advance from a plurality of fixed objects, in a driving area of the autonomous moving body 1 are recorded in advance. For example, the mark is paint (white line or the like) applied to the floor of the driving area or a marker (signboard or the like) installed in the driving area. It is desirable that the mark is a fixed object of which at least a part is observable even in a case where there is a non-fixed object.

The second estimation unit 114 estimates the self-position of the autonomous moving body represented by the six degrees-of-freedom parameters based on the first sensor data, the second sensor data, and the partial parameter estimated by the first estimation unit 113.

The output processing unit 115 outputs the self-position of the autonomous moving body 1 estimated by the map comparison unit 112 or the second estimation unit 114 to a control device (not shown) that controls an operation of the autonomous moving body 1.

### Processing Flow of Self-Position Estimation Device

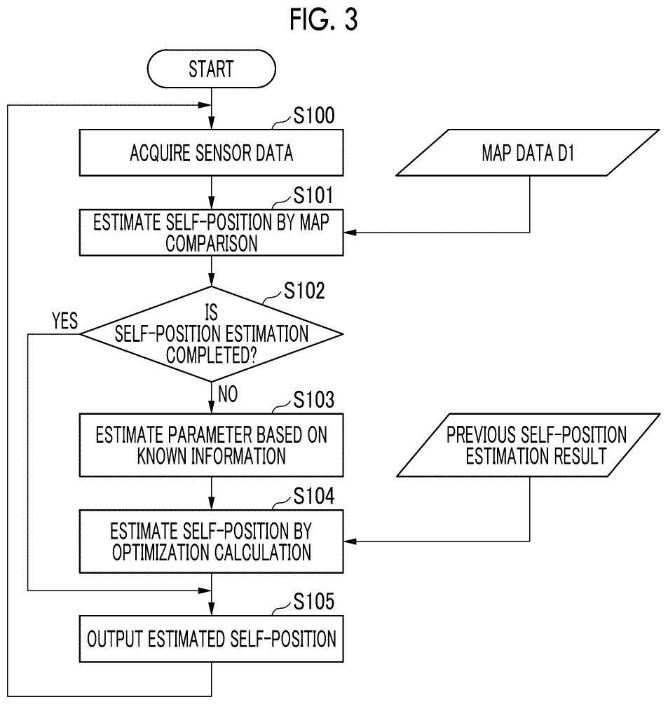

FIG. 3 is a flowchart showing an example of processing of the self-position estimation device according to the first embodiment.

Hereinafter, a flow of processing of estimating the self-position of the autonomous moving body 1 via the self-position estimation device 10 will be described with reference to FIG. 3.

First, the first acquisition unit 110 acquires the first sensor data from the first sensor 20. In addition, the second acquisition unit 111 acquires the second sensor data from the second sensor 21 (step S100). In the present embodiment, the first sensor data is image data representing a latest frame of a video captured by the camera, and the second sensor data is the acceleration and the angular velocity of the autonomous moving body 1 measured by the IMU.

Next, the map comparison unit 112 collates the first sensor data with the map data D1 to estimate the self-position of the autonomous moving body 1 (step S101). For example, the map comparison unit 112 collates each sample data of the first sensor data and the map data D1 acquired by the first acquisition unit 110 using known pattern matching processing, and extracts sample data having a predetermined degree of match or more and having the highest degree of match as data that matches the first sensor data. The map comparison unit 112 estimates the self-position attached to the extracted sample data as the self-position of the autonomous moving body 1 at a first sensor data acquisition time point.

For example, the scenery of the driving area at the time of generating the map data D1 and the scenery of the driving area in a case where the autonomous moving body 1 actually runs may be different from each other, for example, in a case where a package is temporarily placed on a shelf or a floor. In this case, the sample data that matches the first sensor data is not present in the map data D1, and the self-position of the autonomous moving body 1 cannot be estimated. Therefore, the self-position estimation device 10 determines whether or not the estimation of the self-position of the autonomous moving body 1 is completed by the map comparison (step S102).

In a case where the map comparison unit 112 has completed the estimation of the self-position through the map comparison (step S102; YES), the output processing unit 115 outputs the self-position estimated by the map comparison unit 112 to the control device (not shown) of the autonomous moving body 1 (step S105). In addition, the self-position estimation device 10 returns to step S100 and executes the series of processing of FIG. 3 again.

On the other hand, in a case where the map comparison unit 112 cannot estimate the self-position by the map comparison (step S102; NO), the process proceeds to the self-position estimation processing by the first estimation unit 113 and the second estimation unit 114.

First, the first estimation unit 113 performs processing of estimating at least one parameter among the six degrees-of-freedom parameters representing the self-position of the autonomous moving body 1 based on the mark included in the first sensor data and on the known information D2 (step S103). In the present embodiment, an aspect in which the mark is a white line provided on the floor of the driving area will be described as an example. In other embodiments, paint applied to a wall or a ceiling of the driving area may be used as a mark.

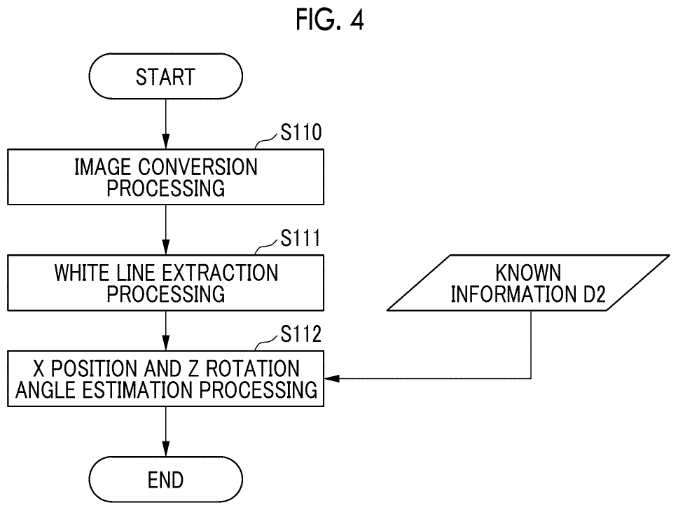

FIG. 4 is a flowchart showing an example of processing of the first estimation unit according to the first embodiment.

The processing of the first estimation unit 113 will be described with reference to FIG. 4. First, the first estimation unit 113 performs predetermined image conversion processing on the first sensor data (step S110). The image conversion processing is, for example, processing such as general distortion correction and conversion to a bird's-eye view.

Next, the first estimation unit 113 performs processing of extracting the white line from the first sensor data after the image conversion processing (step S111). For example, the first estimation unit 113 extracts the white line included in the first sensor data by further performing binarization processing on the first sensor data.

In addition, the first estimation unit 113 performs processing of estimating the position of the autonomous moving body 1 on the Xw axis and the rotation angle (posture) around the Zw axis based on the white line extracted from the first sensor data and on the known information D2 (step S112).

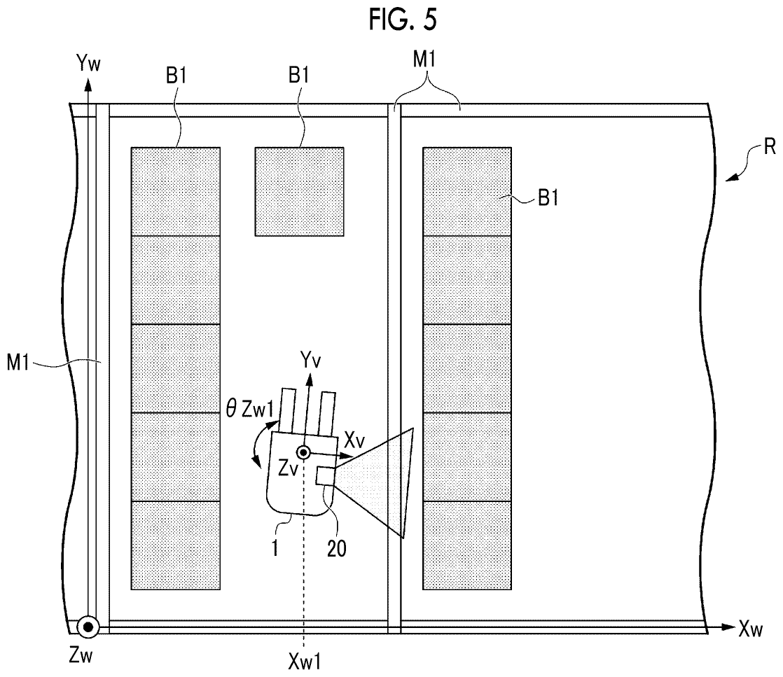

FIG. 5 is a diagram showing a function of the self-position estimation device according to the first embodiment.

As shown in FIG. 5, a white line M1 is provided on the floor of a driving area R. In addition, even in a case where a package B1 is temporarily placed on the floor or the shelf of the driving area R, at least any one of the white lines M1 (in the example of FIG. 5, the white line M1 on the right side of the autonomous moving body 1) is provided at a position where the white line M1 can be observed by the first sensor 20 without being hidden by the package B1. In the example of FIG. 5, a left-right direction of the autonomous moving body 1 (vehicle coordinate system) is represented by an Xv axis, a front-rear direction is represented by an Yv axis, and a vertical direction is represented by a Zv axis. In addition, a horizontal direction (for example, an east-west direction and a north-south direction) of the driving area R (world coordinate system) is represented by an Xw axis and an Yw axis, and a vertical direction is represented by a Zw axis.

In the known information D2, information indicating at which position in the driving area R the white line M1 is provided and at what angle the white line M1 is provided, information indicating a width of the white line M1, and the like are recorded in advance. For example, the first estimation unit 113 specifies which driving path in the driving area R the autonomous moving body 1 enters from a previous self-position estimation result of the map comparison unit 112, information on a predetermined driving route, and the like, and extracts information on the white line M1 drawn on the driving path to which the autonomous moving body 1 enters from the known information D2. In addition, in a case where identification information (a driving path number, a barcode, or the like) of the driving path is printed on the white line M1, the first estimation unit 113 may read the identification information via known character recognition processing, barcode reading processing, or the like from the first sensor data, and extract information related to the white line M1 specified by the identification information from the known information D2.

The first estimation unit 113 can estimate the two degrees-of-freedom parameters (partial parameters) of a position Xw1 in the world coordinate system of the autonomous moving body 1 in the Xw axis direction and a rotation angle θZw1 in the world coordinate system of the autonomous moving body 1 around the Zw axis based on the information of the white line M1 extracted from the known information D2 and on the appearance (size, inclination, and the like) of the white line M1 in the first sensor data (image data).

Next, returning to FIG. 3, the second estimation unit 114 executes the self-position estimation processing by the optimization calculation (step S104).

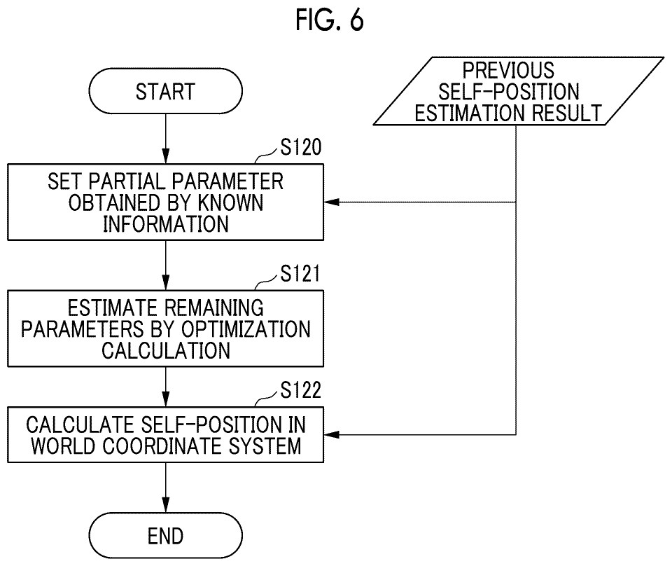

FIG. 6 is a flowchart showing an example of processing of the second estimation unit according to the first embodiment.

The processing of the second estimation unit 114 will be described with reference to FIG. 6.

First, the second estimation unit 114 sets the self-position (partial parameter) obtained by the first estimation unit 113 using the known information D2 (step S120). The optimization calculation in the self-position estimation is calculated using a change (odometry) of a relative position and posture from a previous state (previous frame). Therefore, in the present embodiment, the position Xw1 in the Xw axis and the rotation angle θZw1 around the Zw axis estimated by the first estimation unit 113 are converted into and set as relative values obtained by subtracting the Xw and θZw of the self-position estimation result of the previous frame.

Next, the second estimation unit 114 estimates the relative values to the previous frame, with respect to the four degrees-of-freedom parameters of positions Yw1 and Zw1 in the Yw axis and Zw axis directions and rotation angles θXw1 and θYw1 around the Xw axis and the Yw axis, excluding the two degrees-of-freedom parameters Xw1 and θZw1 estimated by the first estimation unit 113, by the optimization calculation (step S121). Specifically, the second estimation unit 114 fixes the relative values of Xw1 and θZw1 and solves the following Expression (1) to obtain the relative values of the remaining four degrees-of-freedom parameters.

$$\begin{matrix}[ Expression 1 ] & \\ {min}_{χ} \{ {\sum }_{k ∈ B} {‖ {r}_{B} ( {\hat{z}}_{{b}_{k + 1}}^{{b}_{k}} , χ ) ‖}_{{P}_{{b}_{k + 1}}^{{b}_{k}}}^{2} + {\sum }_{( l , j ) ∈ C} ρ ( {‖ {r}_{C} ( {\hat{z}}_{l}^{{C}_{j}} , χ ) ‖}_{{P}_{l}^{{C}_{j}}}^{2} ) \} & ( 1 )\end{matrix}$$

In Expression (1), χ is an estimated value of the amount of change in the self-position from a previous frame f to a latest frame f+1 (relative value to the previous frame). In addition, the first term in the curly braces of Expression (1) represents a residual (IMU residual) between the position and posture change from the previous frame f to the latest frame f+1 and the IMU integrated value during the period, and the second term represents an image re-projection error (image residual) of the position and posture change from the previous frame f to the latest frame f+1.

Next, the second estimation unit 114 calculates the self-position of the autonomous moving body 1 in the world coordinate system of the current frame based on the relative value of each parameter obtained in steps S120 and S121 with respect to the previous frame and the self-position estimation result of the previous frame (step S122).

In addition, returning to FIG. 3, the output processing unit 115 outputs the self-position (six degrees-of-freedom parameters) estimated by the first estimation unit 113 and the second estimation unit 114 to the control device (not shown) of the autonomous moving body 1 (step S105). In addition, the self-position estimation device 10 returns to step S100 and executes the series of processing of FIG. 3 again.

### Actions and Effects

As described above, the self-position estimation device 10 according to the present embodiment includes the first acquisition unit 110 that acquires the first sensor data, the second acquisition unit 111 that acquires the second sensor data, the first estimation unit 113 that estimates the partial parameter which is a part of the six degrees-of-freedom parameters representing the self-position of the autonomous moving body 1 based on the mark included in the first sensor data and on the known information D2, and the second estimation unit 114 that estimates the remaining parameters based on the first sensor data, the second sensor data, and the partial parameter estimated by the first estimation unit 113.

As described above, the self-position estimation device 10 can suppress the cumulative error in the optimization calculation and accurately estimate the self-position of the autonomous moving body 1 by estimating a part of parameters by using the known information D2 that can be indirectly observed from the first sensor data.

In addition, the second estimation unit 114 estimates a parameter other than a partial parameter estimated by the first estimation unit 113 among the six degrees-of-freedom parameters.

In this way, the self-position estimation device 10 can more effectively suppress the influence of the cumulative error since a part of parameters is known and only other parameters need to be obtained. In addition, the self-position estimation device 10 can perform the optimization calculation at high speed and with a low load.

In addition, the mark is a white line M1 (paint) that is applied to the driving area R in advance, and the first estimation unit 113 estimates, as the partial parameter, a position Xw1 in the Xw axis direction and a posture θZw1 represented by rotation around the Zw axis among the six degrees-of-freedom parameters based on the white line M1 extracted from the first sensor data and on the known information D2.

In this way, the self-position estimation device 10 can accurately estimate two degrees-of-freedom parameters among the six degrees-of-freedom parameters from the white line M1 of the driving area R. Accordingly, the self-position estimation device 10 can more effectively suppress the influence of the cumulative error in the estimation of the other parameters of four degrees-of-freedom parameters.

### Second Embodiment

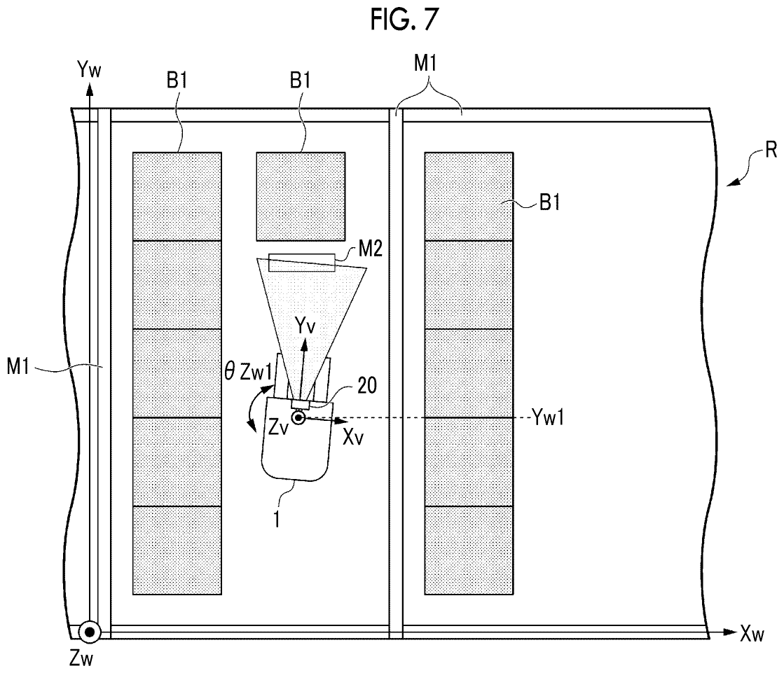

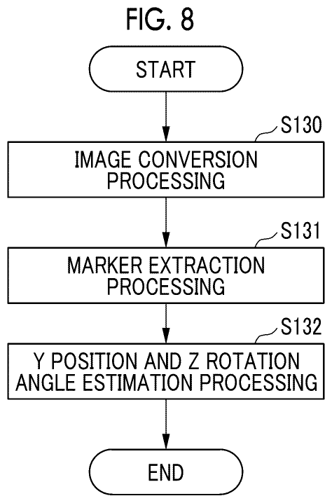

Hereinafter, a second embodiment will be described in detail with reference to FIGS. 7 and 8. In the configuration of the second embodiment, the same components as those of the first embodiment will be described using the same reference numerals as those of the first embodiment.

FIG. 7 is a diagram showing a function of the self-position estimation device according to the second embodiment.

In the first embodiment described above, an example in which the first estimation unit 113 of the self-position estimation device 10 estimates two degrees-of-freedom parameters among six degrees-of-freedom parameters using the white line M1 of the driving area R as a mark has been described. On the other hand, the first estimation unit 113 of the self-position estimation device 10 according to the present embodiment estimates two degrees-of-freedom parameters among six degrees-of-freedom parameters using a marker M2 (signboard or the like) installed in the driving area R as a mark as in the example of FIG. 8. The marker M2 is installed at a position where the marker M2 can be observed by the first sensor 20 without being hidden by the package B1 or the like.

### Processing Flow of Self-Position Estimation Device

FIG. 8 is a flowchart showing an example of processing of the first estimation unit according to the second embodiment.

The first estimation unit 113 according to the present embodiment executes the processing of FIG. 8 instead of the processing of the first embodiment (FIG. 4).

First, as shown in FIG. 8, the first estimation unit 113 performs predetermined image conversion processing on the first sensor data (step S130). The processing is the same as in step S110 of FIG. 4.

Next, the first estimation unit 113 performs processing of detecting the marker M2 by performing known edge detection processing, pattern recognition processing, or the like on the first sensor data after the image conversion processing (step S131).

In addition, the first estimation unit 113 performs processing of estimating the position of the autonomous moving body 1 on the Yw axis and the rotation angle around the Zw axis based on the white line extracted from the first sensor data and on the known information D2 (step S132).

In the known information D2, information indicating a position and an angle at which the marker M2 is installed in the driving area R, information indicating a size of the marker M2, and the like are recorded in advance. As in the first embodiment, the first estimation unit 113 specifies which driving path in the driving area R the autonomous moving body 1 enters from the previous self-position estimation result of the map comparison unit 112, the information on the predetermined driving route, and the like, and extracts the information on the marker M2 installed on the driving path to which the autonomous moving body 1 enters from the known information D2. In addition, in a case where identification information (a driving path number, a barcode, or the like) of the driving path is printed on the marker M2, the first estimation unit 113 may read the identification information via known character recognition processing, barcode reading processing, or the like from the first sensor data, and extract information related to the marker M2 specified by the identification information from the known information D2.

The first estimation unit 113 can estimate two degrees-of-freedom parameters (partial parameters) of the position Yw1 in the world coordinate system of the autonomous moving body 1 in the Yw axis direction and the rotation angle θZw1 around the Zw axis based on the information of the marker M2 extracted from the known information D2 and on the appearance (size, inclination, and the like) of the marker M2 in the first sensor data (image data).

Subsequent processing (steps S104 and S105 in FIG. 3) is the same as that of the first embodiment.

### Actions and Effects

As described above, in the present embodiment, the mark is the marker M2 installed in advance in the driving area R, and the first estimation unit 113 estimates, as the partial parameter, the position Yw1 in the Yw axis direction and the posture θZw1 represented by the rotation around the Zw axis among the six degrees-of-freedom parameters, based on the marker M2 extracted from the first sensor data and on the known information D2.

In this way, the self-position estimation device 10 can accurately estimate two degrees-of-freedom parameters among the six degrees-of-freedom parameters from the marker M2 of the driving area R. Accordingly, the self-position estimation device 10 can more effectively suppress the influence of the cumulative error in the estimation of the other parameters of four degrees-of-freedom parameters.

In addition, in another embodiment, the first estimation unit 113 of the self-position estimation device 10 may extract both the white line M1 and the marker M2 as the mark and may estimate two degrees-of-freedom parameters or three degrees-of-freedom parameters among the six degrees-of-freedom parameters. For example, in a case where only the white line M1 is detected from the first sensor data, the first estimation unit 113 estimates the two degrees-of-freedom parameters of Xw1 and θZw1 in the same manner as in the first embodiment. In addition, in a case where only the marker M2 is detected from the first sensor data, the first estimation unit 113 estimates the two degrees-of-freedom parameters of Yw1 and θZw1 in the same manner as in the second embodiment. Further, in a case where both the white line M1 and the marker M2 are detected from the first sensor data, the first estimation unit 113 estimates the three degrees-of-freedom parameters of Xw1, Yw1, and θZw1 based on the white line M1 and the marker M2. In this way, at least one of the white line M1 or the marker M2 may be installed according to the disposition of the shelf or the like in the driving area R, so that it is possible to flexibly respond to the driving area R of various layouts. In addition, in a case where the first estimation unit 113 can estimate the three degrees-of-freedom parameters from both the white line M1 and the marker M2, the influence of the cumulative error can be more effectively suppressed in the optimization calculation of the second estimation unit 114.

### Third Embodiment

Hereinafter, a third embodiment will be described in detail with reference to

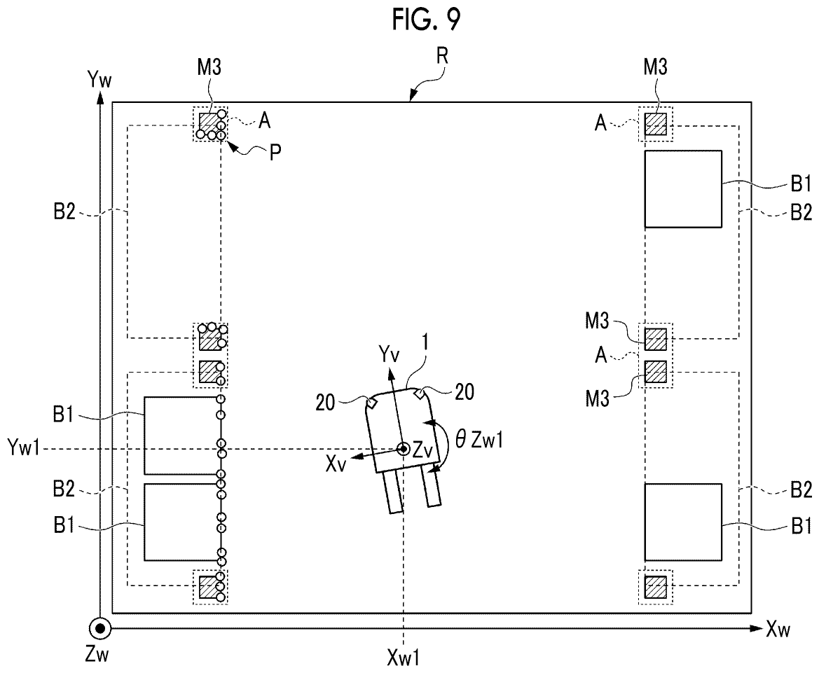

FIGS. 9 to 13. In the configuration of the third embodiment, the same components as those of the first and second embodiments will be denoted by the same reference numerals as those of the first and second embodiments.

FIG. 9 is a first diagram showing a function of the self-position estimation device according to the third embodiment.

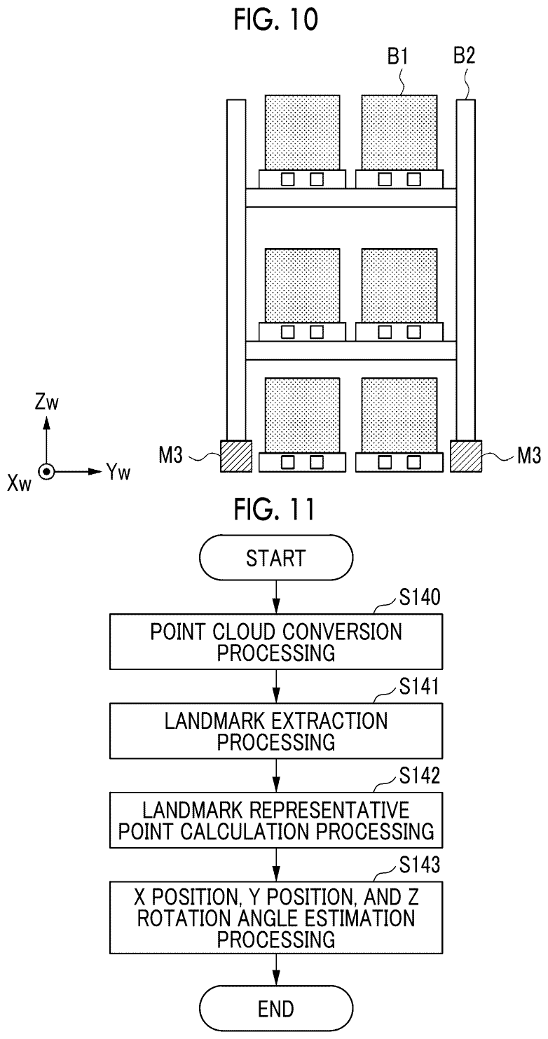

FIG. 10 is a second diagram for describing the function of the self-position estimation device according to the third embodiment.

In the first and second embodiments described above, an example in which the first estimation unit 113 of the self-position estimation device 10 estimates two degrees-of-freedom parameters among six degrees-of-freedom parameters using the white line M1 or the marker M2 of the driving area R as a mark has been described. On the other hand, as shown in FIGS. 9 and 10, the first estimation unit 113 of the self-position estimation device 10 according to the present embodiment estimates three degrees-of-freedom parameters among six degrees-of-freedom parameters using a landmark M3 attached to the fixed object in the driving area R as a mark.

FIG. 9 is a view of the driving area R as viewed from above in the vertical direction (+Zw), and FIG. 10 is a view of a shelf B2 as viewed from one side in the horizontal direction (+Xw). As shown in FIGS. 9 and 10, the landmark M3 is attached to a lower portion (foot) of a column of the shelf B2 on which the package B1 is placed, so that the landmark M3 can be observed by the first sensor 20 without being hidden by the package B1 or the like.

In addition, in the present embodiment, the first sensor 20 of the autonomous moving body 1 is light detection and ranging (LiDAR), and acquires point cloud data P of a fixed object and a non-fixed object around the autonomous moving body 1. In addition, in step S100 of FIG. 3, the first acquisition unit 110 of the self-position estimation device 10 acquires the first sensor data, which is the point cloud data, from the first sensor 20.

### Processing Flow of Self-Position Estimation Device

FIG. 11 is a flowchart showing an example of processing of the first estimation unit according to the third embodiment.

The first estimation unit 113 according to the present embodiment executes the processing of FIG. 11 instead of the processing of the first embodiment (FIG. 4) or the second embodiment (FIG. 8).

First, as shown in FIG. 11, the first estimation unit 113 performs predetermined conversion processing on the first sensor data (point cloud data P) (step S140). This conversion processing is, for example, general distortion correction, conversion processing into a world coordinate system, or the like.

Next, the first estimation unit 113 performs processing of extracting the landmark M3 from the first sensor data after the conversion processing (step S141).

For example, in the known information D2, information indicating a position and an angle at which each landmark M3 is installed in the driving area R, and information indicating a shape, a size, and the like of each landmark M3 are recorded in advance. In addition, the known information D2 records the position of a region (presence region A) in which each landmark M3 is included. For example, as shown in FIG. 9, the presence region A is a virtual rectangular region centered on each landmark M3, and is set to be larger than the horizontal direction size of the landmark M3 by a predetermined margin. In addition, in a case where a plurality of landmarks M3 are provided adjacent to each other, the presence region A may be set to include the plurality of adjacent landmarks M3.

The first estimation unit 113 specifies a region corresponding to the presence region A of the landmark M3 from the first sensor data based on the previous self-position estimation result and the known information D2, and extracts the point cloud data P included in the presence region A as the point cloud data P of the landmark M3.

In addition, the first estimation unit 113 performs processing of calculating a representative point RP of the landmark M3 based on the extracted point cloud data (step S142).

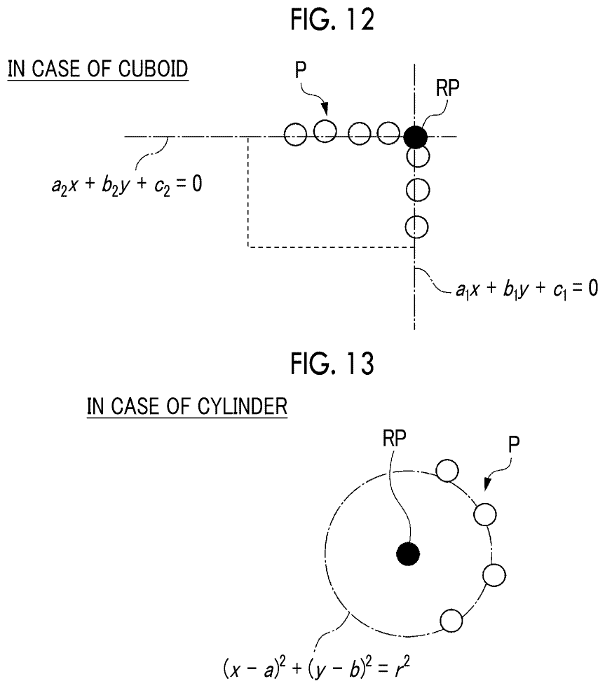

FIG. 12 is a third diagram for describing the function of the self-position estimation device according to the third embodiment.

FIG. 12 shows an example in which the shape of the landmark M3 is a rectangular parallelepiped. In this case, the first estimation unit 113 fits two straight lines represented by the following Expressions (2) and (3) to a point cloud, and extracts an intersection (angle) of these straight lines as the representative point RP of the landmark M3.

$$\begin{matrix}[ Expression 2 ] & \\ {a}_{1} x + {b}_{1} y + {c}_{1} = 0 & ( 2 )\end{matrix}$$

$$\begin{matrix}[ Expression 3 ] & \\ {a}_{2} x + {b}_{2} y + {c}_{2} = 0 & ( 3 )\end{matrix}$$

FIG. 13 is a third diagram for describing the function of the self-position estimation device according to the third embodiment.

FIG. 13 shows an example in which the shape of the landmark M3 is a cylinder. In this case, the first estimation unit 113 fits the Expression of a circle represented by the following Expression (4) and the point cloud, and extracts a center (a, b) of the circle where the error is minimized as the representative point RP of the landmark M3.

$$\begin{matrix}[ Formula 4 ] & \\ {( x - a )}^{2} + {( y - b )}^{2} = {r}^{2} & ( 4 )\end{matrix}$$

Next, the first estimation unit 113 estimates the three degrees-of-freedom parameters of the position Xw1 and the position Yw1 of the autonomous moving body 1 in the Xw axis direction and the Yw axis direction and the rotation angle θZw1 around the Zw axis, based on the position coordinates of the representative point RP in the vehicle coordinate system calculated in step S143 and the position coordinates of the representative point of the landmark M3 in the world coordinate system recorded in the known information D2, for each landmark M3 extracted from the first sensor data (step S143).

It should be noted that the landmark M3 having a different shape or the landmark M3 having a different reflectivity may be disposed for each driving path of the driving area R or each shelf B2. In this case, the first estimation unit 113 reads out the information of the landmark M3 that matches the shape or the reflectivity detected from the point cloud data P from the known information D2, and estimates the parameter. Accordingly, the first estimation unit 113 can accurately estimate the three degrees-of-freedom parameters after narrowing down the driving path of the autonomous moving body 1 or the vicinity of which shelf B2 the autonomous moving body 1 is traveling near.

Subsequent processing (steps S104 and S105 in FIG. 3) is the same as that of the first embodiment.

### Actions and Effects

As described above, in the self-position estimation device 10 according to the present embodiment, the first acquisition unit 110 acquires the first sensor data, which is the point cloud data P, from the first sensor 20. In addition, the mark is a landmark M3 attached to a fixed object (a lower portion of the shelf B2), and the first estimation unit 113 estimates, as a partial parameter, a position Xw1 and a position Yw1 in the Xw axis direction and the Yw axis direction, and a posture θZw1 represented by rotation around the Zw axis, among the six degrees-of-freedom parameters, based on the landmark M3 extracted from the first sensor data and on the known information D2.

In this way, the self-position estimation device 10 can estimate a part of parameters among six degrees-of-freedom parameters from the point cloud data P and the known information D2 even for the autonomous moving body 1 in which the LiDAR is equipped as the first sensor 20. In addition, the first estimation unit 113 can more accurately estimate the three degrees-of-freedom parameters based on the positional relationship and the angle with the plurality of landmarks M3 detected from the first sensor data. Accordingly, the self-position estimation device 10 can estimate the self-position of the autonomous moving body 1 with higher accuracy.

### Fourth Embodiment

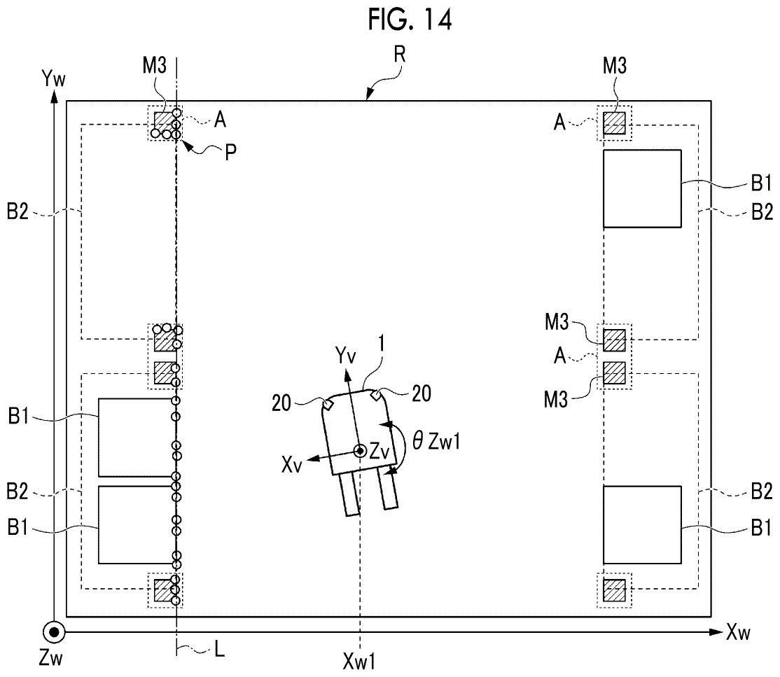

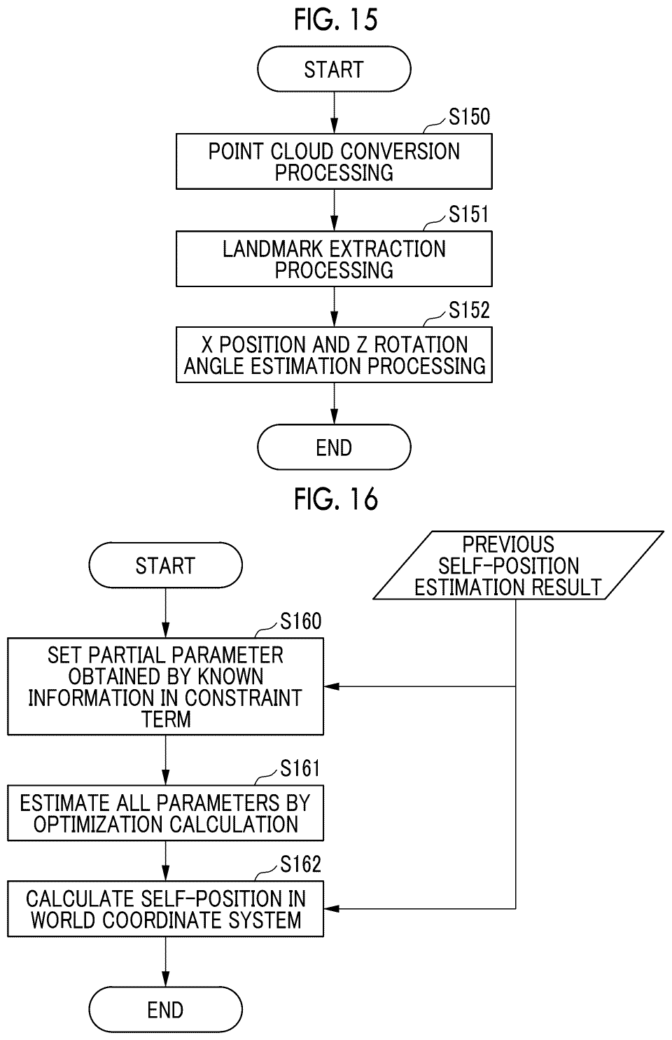

Hereinafter, a fourth embodiment will be described in detail with reference to FIGS. 14 to 15. In the configuration of the fourth embodiment, the same components as those of the first to third embodiments will be denoted by the same reference numerals as those of the first to third embodiments.

FIG. 14 is a diagram showing a function of the self-position estimation device according to the fourth embodiment.

In the third embodiment, an example in which the first estimation unit 113 of the self-position estimation device 10 obtains the three degrees-of-freedom parameters (Xw1, Yw1, θZw1) of the autonomous moving body 1 based on the representative point RP of each landmark M3 has been described. On the other hand, in the present embodiment, as shown in FIG. 14, the first estimation unit 113 disposes a plurality of landmarks M3 in a row on, for example, a straight line, and compares a shape (straight line L) obtained by connecting the point cloud data of the plurality of landmarks M3 with a virtual line with a shape obtained from the actual disposition of the landmarks M3 to estimate the two degrees-of-freedom parameters (Xw1, θZw1) of the autonomous moving body 1.

### Processing Flow of Self-Position Estimation Device

FIG. 15 is a flowchart showing an example of processing of the first estimation unit according to the fourth embodiment.

The first estimation unit 113 according to the present embodiment executes the processing of FIG. 15 instead of the processing of the third embodiment (FIG. 11).

First, as shown in FIG. 15, the first estimation unit 113 performs predetermined conversion processing on the first sensor data (point cloud data P) (step S150). In addition, the first estimation unit 113 performs processing of extracting the landmark M3 from the first sensor data after the conversion processing (step S151). These processes are the same as steps S140 and S141 in FIG. 11.

Next, the first estimation unit 113 performs linear fitting on the point cloud data P of the extracted landmark M3, and estimates the position Xw1 of the autonomous moving body 1 on the Xw axis and the rotation angle θZw1 of the autonomous moving body 1 around the Zw axis based on the distance and the angle with respect to the straight line L and the straight line obtained from the disposition of the landmark M3 recorded in the known information D2 (step S152).

Subsequent processing (steps S104 and S105 in FIG. 3) is the same as that of the first embodiment.

In FIG. 14, an example in which the plurality of landmarks M3 are disposed in a row on a straight line is shown, but the present invention is not limited thereto. In another embodiment, the landmark M3 may be disposed in another shape such as an L-shape.

### Actions and Effects

As described above, in the self-position estimation device 10 according to the present embodiment, the first acquisition unit 110 estimates two degrees-of-freedom parameters of the position Xw1 in the Xw axis direction and the rotation angle θZw1 around the Zw axis based on the shape obtained by connecting the plurality of landmarks M3 extracted from the first sensor data and the shape obtained from the disposition of the landmarks M3 recorded in the known information D2.

In this way, the self-position estimation device 10 can more robustly estimate the self-position from the combination of the plurality of landmarks M3.

### Fifth Embodiment

Hereinafter, a fifth embodiment will be described in detail with reference to

FIG. 16. In the configuration of the fifth embodiment, the same components as those of the first to fourth embodiments will be described using the same reference numerals as those of the first to fourth embodiments.

In each of the above-described embodiments, an example in which the second estimation unit 114 of the self-position estimation device 10 estimates only the parameter other than the partial parameter estimated by the first estimation unit 113 among the six degrees-of-freedom parameters has been described. On the other hand, the second estimation unit 114 according to the present embodiment performs the optimization calculation with the added constraint based on the partial parameter estimated by the first estimation unit 113 to estimate all the six degrees-of-freedom parameters.

### Processing Flow of Self-Position Estimation Device

FIG. 16 is a flowchart showing an example of processing of the second estimation unit according to the fifth embodiment.

The second estimation unit 114 according to the present embodiment executes the processing of FIG. 16 instead of the processing of the first embodiment (FIG. 6). It should be noted that the method by which the first estimation unit 113 estimates the partial parameter may be any of the methods of the first to fourth embodiments.

First, the second estimation unit 114 sets the partial parameter obtained by the first estimation unit 113 using the known information D2 in the constraint term (step S160). Here, as in the first embodiment, the relative value between the previous frame f and the current frame f+1 is set.

Next, the second estimation unit 114 performs the optimization calculation in which the constraint term of the partial parameter estimated by the first estimation unit 113 is added, and estimates the relative value with respect to the previous frame for all the six degrees-of-freedom parameters (step S161). Specifically, the second estimation unit 114 solves the following Expression (5) instead of Expression (1) of the first embodiment to obtain the relative values of all the six degrees-of-freedom parameters.

$$\begin{matrix}[ Expression 5 ] & \\ {min}_{χ} \{ {\sum }_{k ∈ B} {‖ {r}_{B} ( {\hat{z}}_{{b}_{k + 1}}^{{b}_{k}} , χ ) ‖}_{{P}_{{b}_{k + 1}}^{{b}_{k}}}^{2} + {\sum }_{( l , j ) ∈ C} ρ ( {‖ {r}_{C} ( {\hat{z}}_{l}^{{C}_{j}} , χ ) ‖}_{{P}_{l}^{{C}_{j}}}^{2} ) + {r}_{D} ( χ ) \} & ( 5 )\end{matrix}$$

In Expression (5), the third term in the curly braces represents a difference between a self-position x obtained by the optimization calculation and a self-position m (partial parameter) estimated by the first estimation unit 113 from the known information D2, as in Expression (6). In Expression (6), a represents a weight coefficient, p represents position coordinates (x, y, z), and r represents a posture (θx, θy, θz). The weight coefficient a is a value determined by performing parameter tuning before the operation of the autonomous moving body 1.

$$\begin{matrix}[ Expression 6 ] & \\ {r}_{D} ( χ ) = {{a}_{1} ( {χ}_{p} - {m}_{p} )}^{2} + {{a}_{2} ( {χ}_{r} - {m}_{r} )}^{2} & ( 6 )\end{matrix}$$

According to Expression (6), the larger the difference is between the self-position x estimated by the optimization calculation and the self-position m estimated by the first estimation unit 113, the larger the value of the third term of Expression (5) is.

As described above, instead of adopting the parameter estimated by the first estimation unit 113 as it is, the parameter is added as a constraint term in the case of optimization calculation, so that the cumulative error of the entire system can be suppressed while the observation error of the first sensor data is mitigated.

In addition, for example, as in the first embodiment, in a case where the first estimation unit 113 estimates the self-position m (partial parameter) based on the white line M1, there is a possibility that the error of the white line M1 detected from the image is included in the self-position m. Therefore, the second estimation unit 114 may change the value of the weight coefficient a by using the reliability degree in a case where the first estimation unit 113 detects the white line M1 through the image processing. For example, in a case where the detection reliability of the white line M1 is high, the accuracy of the estimation result of the self-position m by the first estimation unit 113 should also be high. Therefore, the second estimation unit 114 increases the value of the weight coefficient a as the reliability of the white line M1 detection becomes higher. By changing the weight coefficient a in this way, the optimization calculation can be performed such that the difference from the self-position m becomes smaller as the estimation accuracy of the self-position m of the first estimation unit 113 becomes higher, and the influence of the error of the self-position m is less likely to be received as the estimation accuracy of the self-position m of the first estimation unit 113 becomes lower.

Next, the second estimation unit 114 calculates the self-position of the autonomous moving body 1 in the world coordinate system of the current frame based on the relative value of each parameter obtained in step S161 with respect to the previous frame and the self-position estimation result of the previous frame (step S162).

Subsequent processing (step S105 in FIG. 3) is the same as that of the first embodiment.

### Actions and Effects

As described above, in the self-position estimation device 10 according to the present embodiment, the second estimation unit 114 performs the optimization calculation with the added constraint based on the partial parameter estimated by the first estimation unit 113 to estimate all the six degrees-of-freedom parameters.

In this way, the self-position estimation device 10 can estimate the self-position with higher accuracy by obtaining the estimated value that matches with other parameters in the optimization calculation while using the parameter estimated by the first estimation unit 113 as a base. In addition, since the self-position estimation device 10 adds a constraint for a part of parameters, the processing speed of the optimization calculation can be improved.

### Sixth Embodiment

Hereinafter, a sixth embodiment will be described in detail with reference to

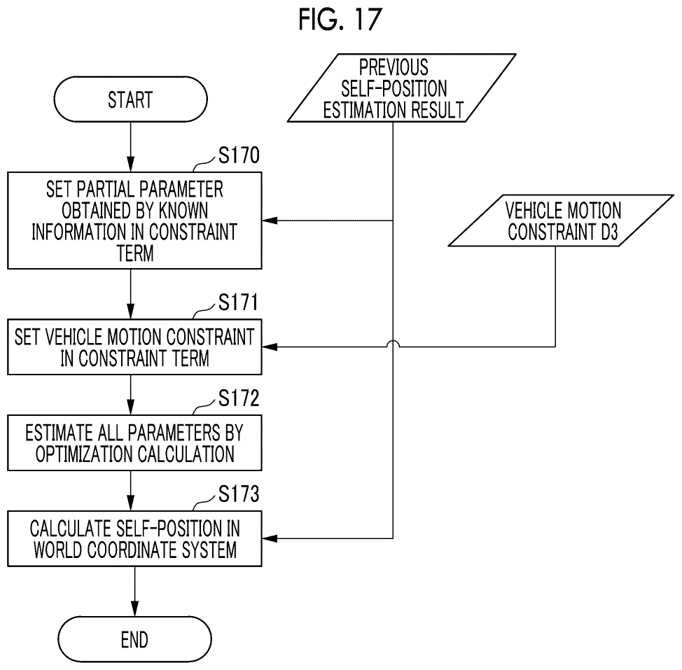

FIG. 17. In the configuration of the sixth embodiment, the same components as those of the first to fifth embodiments will be described using the same reference numerals as those of the first to fifth embodiments.

In the self-position estimation device 10 according to the present embodiment, the second estimation unit 114 performs the optimization calculation to which the constraint based on the motion constraint of the autonomous moving body 1 is added, to estimate all the six degrees-of-freedom parameters.

### Processing Flow of Self-Position Estimation Device

FIG. 17 is a flowchart showing an example of processing of the second estimation unit according to the sixth embodiment.

The second estimation unit 114 according to the present embodiment executes the processing of FIG. 17 instead of the processing of the fifth embodiment (FIG. 16). It should be noted that the method by which the first estimation unit 113 estimates the partial parameter may be any of the methods of the first to fourth embodiments.

First, the second estimation unit 114 sets the partial parameter obtained by the first estimation unit 113 by using the known information D2 as the constraint term of the optimization calculation (Step S170). This processing is the same as step S160 in FIG. 16.

In addition, the second estimation unit 114 sets a vehicle motion constraint D3 recorded in advance in the storage 13 of the autonomous moving body 1 as the constraint term of the optimization calculation (step S171).

For example, in a case where the autonomous moving body 1 is an unmanned forklift that is operated in a logistics warehouse, the autonomous moving body 1 cannot perform an operation (an operation in which one side of a car body is embedded in the floor, an operation in which the car body floats, and the like) in which the car body rotates by a predetermined angle or more in the front-rear direction (rotation around the Xw axis) or the left-right direction (rotation around the Yw axis). The vehicle motion constraint D3 defines a range of positions and postures that the autonomous moving body 1 can take based on such a body characteristic of the autonomous moving body 1, an operation condition of the autonomous moving body 1, a position (for example, a region with a shelf) where the autonomous moving body 1 cannot move, and the like.

Next, the second estimation unit 114 performs the optimization calculation in which the constraint term of the partial parameter estimated by the first estimation unit 113 and the constraint term of the vehicle motion constraint D3 are added, and estimates the relative value with respect to the previous frame for all the six degrees-of-freedom parameters (step S172). Specifically, the second estimation unit 114 solves Expression (5) to obtain the relative values of all the six degrees-of-freedom parameters. In addition, in the present embodiment, the third term of Expression (5) is represented by Expression (7) instead of Expression (6).

$$\begin{matrix}[ Formula 7 ] & \\ {r}_{D} ( χ ) = {{a}_{1} ( {χ}_{p} - {m}_{p 1} )}^{2} + {{a}_{2} ( {χ}_{r} - {m}_{r 1} )}^{2} + {{a}_{2} ( {χ}_{r} - {m}_{r 2} )}^{2} + {{a}_{2} ( {χ}_{r} - {m}_{r 2} )}^{2} & ( 7 )\end{matrix}$$

In Expression (7), a is a weighting coefficient, m1 represents a self-position (partial parameter) estimated by the first estimation unit 113, m2 represents a self-position determined from the vehicle motion constraint D3, p is position coordinates (x, y, z), and r represents a posture (θx, θy, θz).

In addition, the second estimation unit 114 may estimate the movement amount in a vehicle progress direction based on measurement data of an encoder (not shown) that measures the wheel rotation speed of the autonomous moving body 1, and may add the movement amount to the constraint.

According to Expression (7), the larger the difference is between the self-position x estimated by the optimization calculation and the self-position m2 determined from the vehicle motion constraint D3, the larger the value of the third term of Expression (5) is.

Next, the second estimation unit 114 calculates the self-position of the autonomous moving body 1 in the world coordinate system of the current frame based on the relative value of each parameter obtained in step S172 with respect to the previous frame and the self-position estimation result of the previous frame (step S173).

Subsequent processing (step S105 in FIG. 3) is the same as that of the first embodiment.

### Actions and Effects

As described above, in the self-position estimation device 10 according to the present embodiment, the second estimation unit 114 performs the optimization calculation to which the motion constraint of the autonomous moving body 1 is further added to estimate all the six degrees-of-freedom parameters.

In this way, the self-position estimation device 10 can exclude the position and the posture that may not occur for the autonomous moving body 1, and thus the cumulative error can be further suppressed.

While one embodiment has been described in detail with reference to the drawings, the specific configuration is not limited to the above description, and various design changes and the like can be made. That is, in other embodiments, the procedures of processing described above may be changed as appropriate. In addition, some of the processing may be executed in parallel.

The self-position estimation device 10 according to the above-described embodiment may be configured by a single computer, or may be configured by disposing a configuration of the self-position estimation device 10 in a plurality of computers and functioning as the self-position estimation device 10 by the plurality of computers cooperating with each other. In this case, some of the computers constituting the self-position estimation device 10 may be mounted inside the autonomous moving body 1, and the other computers may be provided outside the autonomous moving body 1.

In addition, in the first and second embodiments, an example in which the first sensor 20 is a camera has been described, but the present invention is not limited thereto. In the configurations of the first and second embodiments, a LiDAR may be used as the first sensor 20. Similarly, in the third and fourth embodiments, an example in which the first sensor 20 is the LiDAR has been described, but the present invention is not limited thereto. In the configurations of the third and fourth embodiments, a camera may be used as the first sensor 20.

### Additional Notes

The above-described embodiment is understood as follows, for example.
(1) With a first aspect, a self-position estimation device 10 that estimates a self-position of an autonomous moving body 1 in a driving area R of the autonomous moving body 1 includes a first acquisition unit 110 that acquires first sensor data capable of detecting a fixed object always present in a periphery of the autonomous moving body 1 and a non-fixed object temporarily present in the periphery of the autonomous moving body 1; a second acquisition unit 111 that acquires second sensor data including an acceleration and an angular velocity of the autonomous moving body 1; a first estimation unit 113 that estimates a partial parameter that is a part of six degrees-of-freedom parameters representing a position and a posture of the autonomous moving body 1 in a three-dimensional coordinate system, based on known information D2, in which information including a position in the driving area R of marks M1, M2, and M3 of which each is one fixed object selected in advance from a plurality of fixed objects is recorded, and on the first sensor data; and a second estimation unit 114 that estimates a self-position of the autonomous moving body 1 represented by the six degrees-of-freedom parameters based on the first sensor data, the second sensor data, and the partial parameter.

As described above, the self-position estimation device 10 can suppress the cumulative error in the optimization calculation and accurately estimate the self-position of the autonomous moving body 1 by estimating a part of parameters by using the known information D2 that can be indirectly observed from the first sensor data.
(2) With a second aspect, in the self-position estimation device 10 according to the first aspect, the second estimation unit 114 estimates a parameter other than the partial parameter among the six degrees-of-freedom parameters.

In this way, the self-position estimation device 10 can more effectively suppress the influence of the cumulative error since a part of parameters is known and only other parameters need to be obtained. In addition, the self-position estimation device 10 can perform the optimization calculation at high speed and with a low load.
(3) With a third aspect, in the self-position estimation device 10 according to the first aspect, the second estimation unit 114 estimates all the six degrees-of-freedom parameters by performing optimization calculation to which a constraint based on the partial parameter is added.

In this way, the self-position estimation device 10 can estimate the self-position with higher accuracy by obtaining the estimated value that matches with other parameters in the optimization calculation while using the parameter estimated by the first estimation unit 113 as a base. In addition, since the self-position estimation device 10 adds a constraint for a part of parameters, the processing speed of the optimization calculation can be improved.
(4) With a fourth aspect, in the self-position estimation device 10 according to the third aspect, the second estimation unit 114 estimates all the six degrees-of-freedom parameters by performing optimization calculation to which a motion constraint of the autonomous moving body 1 is further added.

In this way, the self-position estimation device 10 can exclude the position and the posture that may not occur as the autonomous moving body 1, and thus, the cumulative error can be further suppressed.
(5) With a fifth aspect, in the self-position estimation device 10 according to any one of the first to fourth aspects, the mark is at least one of paint M1 applied to the driving area R and a marker M2 installed in the driving area R, and the first estimation unit 113 estimates a position in at least one of a first axis direction and a second axis direction extending in a horizontal direction and a posture represented by rotation around a third axis extending in a vertical direction, among the six degrees-of-freedom parameters, based on at least one of the paint M1 and the marker M2 extracted from the first sensor data and on the known information D2, as the partial parameter.

In this way, the self-position estimation device 10 can accurately estimate two degrees-of-freedom parameters among six degrees-of-freedom parameters from the paint M1 or the marker M2 of the driving area R. In addition, the self-position estimation device 10 can accurately estimate three degrees-of-freedom parameters among six degrees-of-freedom parameters from the combination of the paint M1 and the marker M2. Accordingly, the self-position estimation device 10 can more effectively suppress the influence of the cumulative error in the estimation of the remaining parameters of four degrees-of-freedom parameters or three degrees-of-freedom parameters.
(6) With a sixth aspect, in the self-position estimation device 10 according to any one of the first to fourth aspects, the mark is a landmark M3 attached to a part of the fixed object, and the first estimation unit 113 estimates a position in each of a first axis direction and a second axis direction extending in a horizontal direction and a posture represented by rotation around a third axis extending in a vertical direction, among the six degrees-of-freedom parameters, based on the landmark M3 extracted from the first sensor data and on the known information D2, as the partial parameter.

In this way, the first estimation unit 113 of the self-position estimation device 10 can more accurately estimate the three degrees-of-freedom parameters based on the positional relationship and the angle with the plurality of landmarks M3 detected from the first sensor data. Accordingly, the self-position estimation device 10 can estimate the self-position of the autonomous moving body 1 with higher accuracy.
(7) With a seventh aspect, in the self-position estimation device 10 according to the sixth aspect, the first estimation unit 113 estimates a position in the first axis direction extending in the horizontal direction and the posture represented by the rotation around the third axis extending in the vertical direction, among the six degrees-of-freedom parameters, based on a shape obtained by connecting a plurality of landmarks M3 extracted from the first sensor data and a shape obtained from a disposition of the landmarks M3 recorded in the known information D2, as the partial parameter.

In this way, the self-position estimation device 10 can more robustly estimate the self-position from the combination of the plurality of landmarks M3.
(8) With an eighth aspect, a self-position estimation method that estimates a self-position in a driving area R of an autonomous moving body 1 includes a step of acquiring first sensor data capable of detecting a fixed object always present in a periphery of the autonomous moving body 1 and a non-fixed object temporarily present in the periphery of the autonomous moving body 1; a step of acquiring second sensor data including an acceleration and an angular velocity of the autonomous moving body 1; a step of estimating a partial parameter that is a part of six degrees-of-freedom parameters representing a position and a posture of the autonomous moving body 1 in a three-dimensional coordinate system, based on known information, in which information including a position in the driving area R of marks M1, M2, and M3 of which each is one fixed object selected in advance from a plurality of fixed objects is recorded, and on the first sensor data; and a step of estimating a self-position of the autonomous moving body 1 represented by the six degrees-of-freedom parameters based on the first sensor data, the second sensor data, and the partial parameter.
(9) With a ninth aspect, a program causes a self-position estimation device 10 that estimates a self-position in a driving area of an autonomous moving body 1 to execute: a step of acquiring first sensor data capable of detecting a fixed object always present in a periphery of the autonomous moving body 1 and a non-fixed object temporarily present in the periphery of the autonomous moving body 1; a step of acquiring second sensor data including an acceleration and an angular velocity of the autonomous moving body 1; a step of estimating a partial parameter that is a part of six degrees-of-freedom parameters representing a position and a posture of the autonomous moving body 1 in a three-dimensional coordinate system, based on known information D2, in which information including a position in the driving area R of marks M1, M2, and M3 of which each is one fixed object selected in advance from a plurality of fixed objects is recorded, and on the first sensor data; and a step of estimating a self-position of the autonomous moving body 1 represented by the six degrees-of-freedom parameters based on the first sensor data, the second sensor data, and the partial parameter.

According to the present disclosure, it is possible to provide a self-position estimation device, a self-position estimation method, and a program capable of accurately estimating a position and a posture of an autonomous moving body.

### REFERENCE SIGNS LIST

1: autonomous moving body
10: self-position estimation device
11: processor
110: first acquisition unit
111: second acquisition unit
112: map comparison unit
113: first estimation unit
114: second estimation unit
115: output processing unit
12: memory
13: storage
14: interface
20: first sensor
21: second sensor

1. A self-position estimation device that estimates a self-position in a driving area of an autonomous moving body, the self-position estimation device comprising:
a first acquisition unit that acquires first sensor data capable of detecting a fixed object always present in a periphery of the autonomous moving body and a non-fixed object temporarily present in the periphery of the autonomous moving body;
a second acquisition unit that acquires second sensor data including an acceleration and an angular velocity of the autonomous moving body;
a first estimation unit that estimates a partial parameter that is a part of six degrees-of-freedom parameters representing a position and a posture of the autonomous moving body in a three-dimensional coordinate system, based on known information, in which information including a position in the driving area of a mark that is one fixed object selected in advance from a plurality of fixed objects is recorded, and the on first sensor data; and
a second estimation unit that estimates a self-position of the autonomous moving body represented by the six degrees-of-freedom parameters based on the first sensor data, the second sensor data, and the partial parameter, wherein
the mark is a plurality of landmarks attached to a part of the fixed object, and
the first estimation unit estimates a position in the first axis direction extending in the horizontal direction and the posture represented by the rotation around the third axis extending in the vertical direction, among the six degrees-of-freedom parameters, based on a shape obtained by connecting the plurality of landmarks extracted from the first sensor data and a shape obtained from a disposition of the landmarks recorded in the known information, as the partial parameter.

2. The self-position estimation device according to claim 1,
wherein the second estimation unit estimates a parameter other than the partial parameter among the six degrees-of-freedom parameters.

3. The self-position estimation device according to claim 1,
wherein the second estimation unit estimates all the six degrees-of-freedom parameters by performing optimization calculation to which a constraint based on the partial parameter is added.

4. The self-position estimation device according to claim 3,
wherein the second estimation unit estimates all the six degrees-of-freedom parameters by performing optimization calculation to which a motion constraint of the autonomous moving body is further added.

5. The self-position estimation device according to claim 1,
wherein the mark is at least one of paint applied to the driving area and a marker installed in the driving area, and
the first estimation unit estimates a position in at least one of a first axis direction and a second axis direction extending in a horizontal direction and a posture represented by rotation around a third axis extending in a vertical direction, among the six degrees-of-freedom parameters, based on at least one of the paint and the marker extracted from the first sensor data and on the known information, as the partial parameter.

6-7. (Canceled)

8. A self-position estimation method that estimates a self-position in a driving area of an autonomous moving body, the self-position estimation method comprising:
a step of acquiring first sensor data capable of detecting a fixed object always present in a periphery of the autonomous moving body and a non-fixed object temporarily present in the periphery of the autonomous moving body;
a step of acquiring second sensor data including an acceleration and an angular velocity of the autonomous moving body;
a step of estimating a partial parameter that is a part of six degrees-of-freedom parameters representing a position and a posture of the autonomous moving body in a three-dimensional coordinate system, based on known information, in which information including a position in the driving area of a mark that is one fixed object selected in advance from a plurality of fixed objects is recorded, and on the first sensor data; and
a step of estimating a self-position of the autonomous moving body represented by the six degrees-of-freedom parameters based on the first sensor data, the second sensor data, and the partial parameter, wherein
the mark is a plurality of landmarks attached to a part of the fixed object, and
in the step of acquiring first sensor data, estimating a position in the first axis direction extending in the horizontal direction and the posture represented by the rotation around the third axis extending in the vertical direction, among the six degrees-of-freedom parameters, based on a shape obtained by connecting the plurality of landmarks extracted from the first sensor data and a shape obtained from a disposition of the landmarks recorded in the known information, as the partial parameter.

9. A program that causes a self-position estimation device according to claim 1 to execute:
a step of acquiring first sensor data capable of detecting a fixed object always present in a periphery of the autonomous moving body and a non-fixed object temporarily present in the periphery of the autonomous moving body;
a step of acquiring second sensor data including an acceleration and an angular velocity of the autonomous moving body;
a step of estimating a partial parameter that is a part of six degrees-of-freedom parameters representing a position and a posture of the autonomous moving body in a three-dimensional coordinate system, based on known information, in which information including a position in the driving area of a mark that is one fixed object selected in advance from a plurality of fixed objects is recorded, and on the first sensor data; and
a step of estimating a self-position of the autonomous moving body represented by the six degrees-of-freedom parameters based on the first sensor data, the second sensor data, and the partial parameter, wherein
in the step of acquiring first sensor data, estimating a position in the first axis direction extending in the horizontal direction and the posture represented by the rotation around the third axis extending in the vertical direction, among the six degrees-of-freedom parameters, based on a shape obtained by connecting the plurality of landmarks extracted from the first sensor data and a shape obtained from a disposition of the landmarks recorded in the known information, as the partial parameter.

10. A self-position estimation device that estimates a self-position in a driving area of an autonomous moving body, the self-position estimation device comprising:
a first acquisition unit that acquires first sensor data capable of detecting a fixed object always present in a periphery of the autonomous moving body and a non-fixed object temporarily present in the periphery of the autonomous moving body;
a second acquisition unit that acquires second sensor data including an acceleration and an angular velocity of the autonomous moving body;
a first estimation unit that estimates a partial parameter that is a part of six degrees-of-freedom parameters representing a position and a posture of the autonomous moving body in a three-dimensional coordinate system, based on known information, in which information including a position in the driving area of a mark that is one fixed object selected in advance from a plurality of fixed objects is recorded, and the on first sensor data; and
a second estimation unit that estimates a self-position of the autonomous moving body represented by the six degrees-of-freedom parameters based on the first sensor data, the second sensor data, and the partial parameter, wherein
the mark is a plurality of landmarks attached to a part of the fixed object, and
the first estimation unit estimates a position in each of a first axis direction and a second axis direction extending in a horizontal direction and a posture represented by rotation around a third axis extending in a vertical direction, among the six degrees-of-freedom parameters, based on the plurality of landmarks extracted from the first sensor data and on the known information, as the partial parameter.
